(19) United States
(12) Patent Application Publication
(10) Pub. No.: US 2003/0135506 A1
(43) Pub. Date: Jul. 17, 2003

(54) Method for collating experiences of an interactive internet session

(76) Inventors: Kurt J. Hausheer, Albany, OR (US); William R. Frolik, Albany, OR (US)

Correspondence Address: HEWLETT-PACKARD COMPANY, Intellectual Property Administration, P.O. Box 272400, Fort Collins, CO, 80527-2400, US

(21) Appl. No.: 10/050,582

(22) Filed: Jan. 16, 2002

(51) Int. Cl. G06F 7/00

(52) U.S. Cl. 707/100

(57) ABSTRACT

The present invention provides methods and computer programs for collating experiences of an interactive user Internet session by archiving a plurality of a user's Internet experiences in correspondence with correlated decisions and outcomes and arranging the decisions and outcomes in accordance with a predetermined scheme.

### BACKGROUND OF THE INVENTION

The present invention relates to publication generation of a collection of experiences based on interactive multimedia activities, and in particular, a publication of experiences derived from a user's selections or decisions made while navigating a set of interactive Internet activities.

At the present time, one may interact with the Internet primarily by way of filling out forms to order products, searching for desired items, searching for information, or by sending messages to bulletin boards and the like. Internet addresses can be used to browse the web, to view online catalogs, and to check forum postings, ultimately obtaining information that is educational or otherwise helpful to the user.

Additionally, users may participate in interactive educational experiences or interactive games on the Internet. For example, many universities are offering courses via the Internet so that users may telecommute at their convenience to acquire degrees or other certificates. Some interactive games, when a user's turn occurs, require the user to return to the game, track all interactions, maintain a state or standing, and perhaps offer rewards for attaining certain goals. Currently, no historical compilation of the user's interactive submissions and results is available. Further, there are no computer programs that perform the above in a dynamic, personalized fashion.

### SUMMARY OF THE INVENTION

Aspects of the present invention provide methods and computer programs for collating experiences of an interactive user Internet session by archiving a plurality of a user's Internet experiences in correspondence with correlated decisions and outcomes and arranging the decisions and outcomes in accordance with a predetermined scheme.

### BRIEF DESCRIPTION OF THE DRAWINGS

FIG. 1 is a flow diagram illustrating one embodiment of steps of a method in accordance with the present invention.

FIG. 2 is a flow diagram illustrating another embodiment of steps of a method in accordance the present invention.

FIG. 3 is a block diagram illustrating one embodiment of a computer program in accordance with the present invention.

FIG. 4 is a block diagram illustrating another embodiment of a computer program in accordance with the present invention.

### DETAILED DESCRIPTION OF PREFERRED EMBODIMENTS

The present invention provides methods and computer programs for collating and publishing portions, as well as completed sequences, of user Internet experiences. The selected sequences (or portions thereof) may be printed in book form.

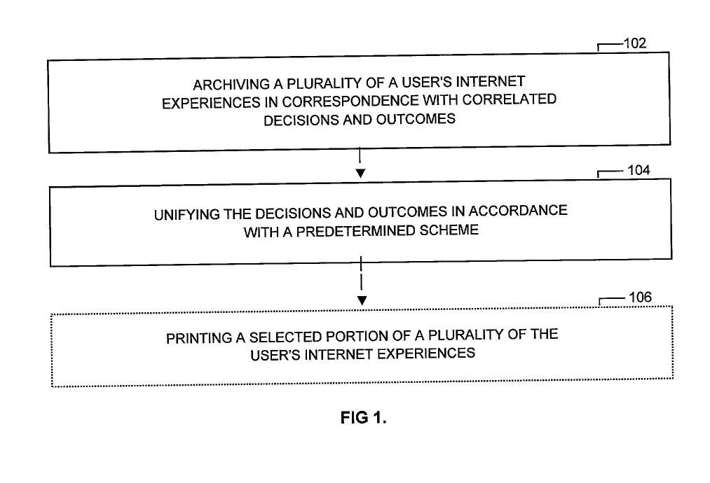

As shown in FIG. 1, embodiments of the invention provide a method for collating experiences of an interactive user Internet session. The method includes archiving 102 a plurality of a user's Internet experiences in correspondence with correlated decisions and outcomes and then arranging 104 the decisions and outcomes in accordance with a predetermined scheme.

In the embodiment of FIG. 1, a predetermined scheme can include any interactive pick-a-path experience. A pick-a-path experience, as contemplated herein, is an entertainment, gaming, simulation, or educational Internet experience that includes the user's selection of decision points and the outcomes that result from the decision points within the experience. Thus, for example, an Internet user may participate in a virtual adventure that includes various pick-a-path decision points within the adventure. When the user selects a particular decision point, the user experiences the adventure as modified according to the outcomes of the decision. To further illustrate, if the user is participating in a virtual adventure in which the user can decide to travel by boat or by train, the predetermined scheme includes outcomes that result from the travel decision.

Thus, in a pick-a-path experience, the user's selections or inputs can determine the path or sequence of chapters presented as well as the content provided within the chapters. This permits each user to have a different set of experiences, within a predetermined scheme, that result from the user's unique set of pick-a-path decisions and the outcomes that result from each pick-a-path decision. This enables users to generate a unique or one-of a-kind experience from these personalization features.

In order to attract users to the hosting website, the pick-a-path experience can incorporate user interactivity and include content that provides “cliff-hanger” anticipation in which the outcome of a portion of the adventure or melodrama is in doubt. The user can then be drawn back to the hosting website so that the user can be presented with the outcome.

As previously mentioned, the pick-a-path experience can also include a plurality of educational activity goals in which the user selects a desired grade level to be achieved. Content is then directed to the user based on the selected grade level. For example, if a user in an educational setting expects to display a high level of proficiency in a given subject, the user may select an “A” grade. The hosting website can then present testing content that is suited for students that are highly proficient in the subject. The user's grade selection and outcomes can then be compiled and published on behalf of the user. Further, the user can cycle through the activities until he or she learns and advances to a higher grade.

As previously mentioned, the pick-a-path experience can also include a simulation or a gaming experience in which the player selects a level or proficiency in a game. Based on the selected skill level, parameters of the game may change. These parameters can include the skill level of other characters encountered within the game's environment, the speed at which the event of the game transpire, as well as other aspects of the game.

The method of FIG. 1 may include printing 106 a selected portion, wherein the selected portion may be the entire portion, of the user's Internet experiences. Where desired, the selected portion may be printed in a quality or style chosen from a plurality of predefined options such as double-sided printing, extra-large type, as well as printing grayscale or full-color images. The selected portion can also be a partial sequence of the user's Internet experiences, a sequence of the user's Internet experiences that comprises logical unit such as lesson or a chapter, or a sequence of the user's Internet experiences that comprises a start-to-finish compilation of a multi-step or multi-decision activity of the user. Other print options, such as font selection, text wrapping and so forth, may also be used. Further, the selected printing option can include preparing low or high-quality portable document formatted files, such as “pdf” files having color backgrounds, borders, and other qualities.

For the start-to-finish compilation, the selected printing option 106 may include dynamically generating front and back book covers that give the resulting publication a look that approaches a high quality, off-the-shelf printed publication. If desired, the covers may be personalized to reflect the user's unique experience resulting from the users selection at the various decision points. This contributes to a sense of personal ownership of the experience in which the user can feel that the book “belongs” to him or her.

The selected printing option 106 can also include dynamically generating an index or a table of contents, dynamically selecting or generating images to accompany written information, dynamically selecting or generating advertisements, dynamically generating a listing of related further reading by the same or a similar author or involving the same or a similar character. Step 106 can also include dynamically generating a book feature, such as personalized character names or characters having certain qualities (for example, good guys or bad guys). In addition, the printing step 106 may include dynamically generating author information and publisher information. Where desired, the start-to-finish compilation may be arranged in a non-book format, such as non-paginated text or as an audio stream (e.g. a book on tape) generated for the visually impaired. The non-book formats can also include non-paginated HTML or other electronic format for display on a computer screen, personal digital assistant, and so forth.

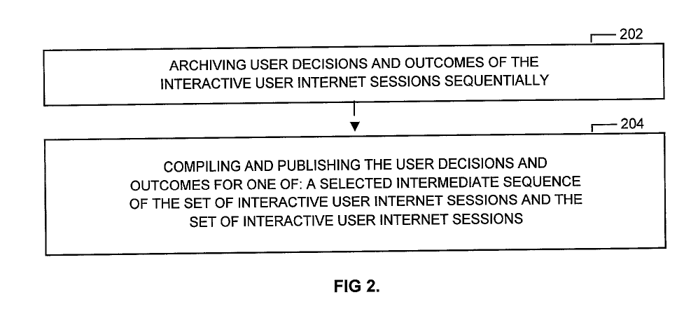

As shown in FIG. 2, the present invention may be embodied as a method of providing and managing a pick-a-path experience for a set of interactive user Internet sessions. In this embodiment, the method includes the steps of archiving 202 user decisions and outcomes of the interactive user Internet sessions sequentially. The method continues at step 204 in which the user decisions and outcomes are compiled and published. In step 204, the user decisions and outcomes for a selected portion of the set of interactive user Internet sessions or the complete set of the interactive user Internet sessions may be published. Step 204 can also include publishing archived user decisions and outcomes for at least one pick-a-path experience that includes an activity goal selected in an educational setting.

In step 204, a predetermined scheme can include instructions for placing advertising on pages to be printed by the user. For example, the predetermined scheme may provide for advertising banners to be inserted on all or on preselected pages only. Further, the predetermined scheme can permit context-sensitive advertising to be placed on pages according to the pick-a-path decisions made by the user. For example, if the user is participating in an adventure, and the user has selected to travel by boat within the adventure, the predetermined scheme can include presenting the user with advertisements related to cruise vacations or other maritime activities.

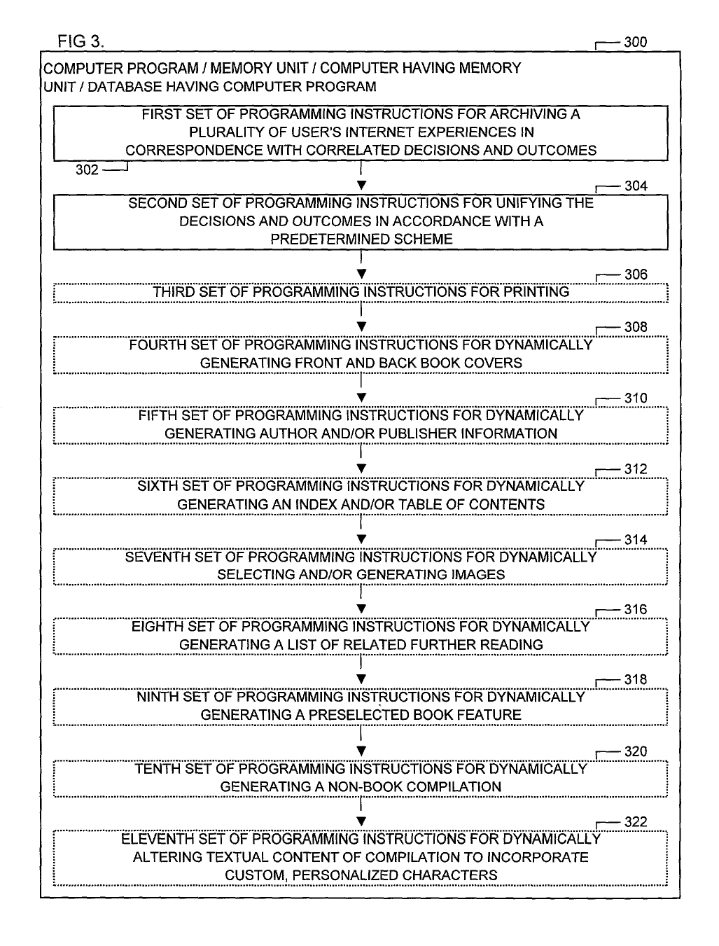

FIG. 3 is a block diagram showing one embodiment of a computer program 300 for arranging experiences of an interactive user Internet session. In this embodiment, a first set 302 of programming instructions is used to archive a plurality of a user's Internet experiences in correspondence with correlated decisions and outcomes. A second set 304 of programming instructions is used for arranging the decisions and outcomes in accordance with a predetermined scheme. Where desired, a third set 306 of programming instructions may be used for printing a selected portion of a plurality of the user's Internet experiences. Typically, the selected portion is a partial sequence of the user's Internet experiences, a sequence of the user's Internet experiences that comprises a chapter, or a sequence of the user's Internet experiences that comprises a start-to-finish compilation of a multi-step activity of the user. Where desired, the third set 306 of programming instructions may include instructions for printing-related qualities such as double-sided pages, ink selection, imposition, font size, ink selection, paper type, etc.

Where desired, a fourth set 308 of programming instructions may allow the dynamic generation of front and back book covers for the start-to-finish compilation. A fifth set 310 of programming instructions may be used for dynamically generating, for the start-to-finish compilation, author information and/or publisher information.

In addition, a sixth set 312 of programming instructions may be provided for dynamically generating an index or a table of contents for the start-to-finish compilation. Also, a seventh set 314 of programming instructions may be used for dynamically selecting or generating images to accompany written information for the start-to-finish compilation. An eighth set 316 of programming instructions can be used to dynamically generate a list of related further reading for the start-to-finish compilation. A ninth set 318 of programming instructions may be used for dynamically generating a preselected book feature for the start-to-finish compilation. A tenth set 320 of programming instructions may be used for dynamically generating a non-book compilation for the start-to-finish compilation. An eleventh set 322 of programming instructions may be used to dynamically alter the start-to-finish compilation to incorporate custom, personalized characters. This can include customizing a character to assume the user's name, hometown, occupation, and so forth.

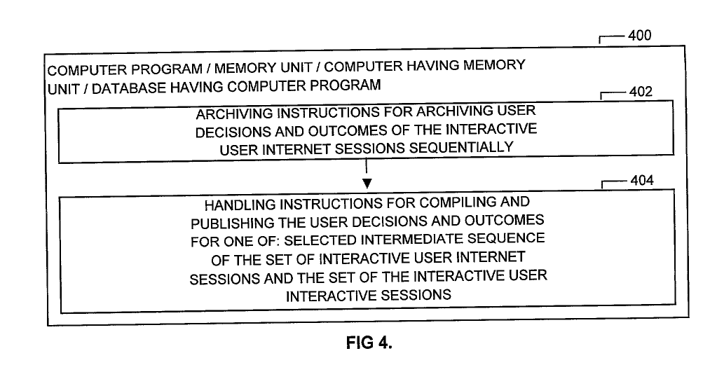

FIG. 4 is a block diagram illustrating implementation of a computer program 400 that provides and manages a pick-a-path experience for a set of interactive user Internet sessions in accordance with the present invention. The computer program 400 includes archiving instructions 402 for archiving user decisions and outcomes of the interactive user Internet sessions sequentially and handling instructions 404 for compiling and publishing the user decisions and outcomes for one of: a selected portion of the interactive user Internet sessions and the complete set of the interactive user Internet sessions.

The computer program of the present invention may be stored on a memory unit 300, 400 such as on a compact disc, a hard drive of a computer, a floppy disk, a memory unit of a shared database, and the like.

Thus, methods and computer programs have been described according to the present invention. Many modifications and variations may be made to the techniques and structures described and illustrated herein without departing from the spirit and scope of the invention. Accordingly, it should be understood that the methods and computer programs described herein are illustrative only and are not limiting upon the scope of the invention.

What is claimed is:

1. A method for collating experiences of an interactive user Internet session, comprising the steps of:
archiving a plurality of a user's Internet experiences in correspondence with correlated decisions and outcomes; and
arranging the decisions and outcomes in accordance with a predetermined scheme.

2. The method of claim 1 further including a step of printing a selected portion of a plurality of the user's Internet experiences in accordance with a selected printing option.

3. The method of claim 2 wherein the selected portion is one of:
a partial sequence of the user's Internet experiences;
a sequence of the user's Internet experiences that comprises a logical unit; and
a sequence of the user's Internet experiences that comprises a start-to-finish compilation of a multi-step activity of the user.

4. The method of claim 3 wherein the selected printing option includes, for the start-to-finish compilation, dynamically generating at least one of a front and a back book cover.

5. The method of claim 3, wherein the selected printing option includes, for the start-to-finish compilation, dynamically generating one of table of contents and an index.

6. The method of claim 3, wherein the selected printing option includes one of:
dynamically generating images to accompany written information for the start-to-finish compilation; and
dynamically selecting images to accompany written information for the start-to-finish compilation.

7. The method of claim 3, wherein the selected printing option includes, for the start-to-finish compilation, dynamically generating a listing of related further reading.

8. The method of claim 3, wherein the selected printing option includes, for the start-to-finish compilation, dynamically generating a preselected book feature.

9. The method of claim 1, wherein the arranging step further comprises arranging a start-to-finish compilation in a non-book format.

10. The method of claim 9, wherein the arranging step further comprises generating an audio stream.

11. A method of providing and managing a pick-a-path experience for a set of interactive user Internet sessions, comprising the steps of:
archiving user decisions and outcomes of the interactive user Internet sessions; and
compiling and publishing the user decisions and outcomes for a selected portion of a complete set of the interactive user Internet sessions.

12. The method of claim 11, wherein the pick-a-path experience is one of: an educational experience, a simulation, an entertainment experience, and a gaming experience.

13. The method of claim 11, wherein the pick-a-path experience includes a plurality of activity goals.

14. The method of claim 13, wherein the step of compiling and publishing includes publishing user decisions and outcomes that have been archived for at least one of the activity goals.

15. The method of claim 11, wherein the pick-a-path experience incorporates user interactivity and is designed to include content that provides cliff-hanger anticipation to attract users to a hosting website.

16. The method of claim 11, wherein compiling and publishing the user decisions and outcomes for one of: a selected portion of the set of interactive user Internet sessions and the set of the interactive user Internet sessions includes incorporating advertising on printed pages in accordance with a predetermined scheme.

17. A computer program for collating experiences of an interactive user Internet session, comprising:
programming instructions for archiving a plurality of a user's Internet experiences in correspondence with correlated decisions and outcomes; and
programming instructions for arranging the decisions and outcomes in accordance with a predetermined scheme.

18. The computer program of claim 17, further including programming instructions for printing a selected portion of a plurality of the user's Internet experiences.

19. The computer program of claim 17, wherein the selected portion is one of:
a partial sequence of the user's Internet experiences;
a sequence of the user's Internet experiences that comprises a logical unit; and
a sequence of the user's Internet experiences that comprises a start-to-finish compilation of a multi-step activity of the user.

20. The computer program of claim 19, further including programming instructions for dynamically altering the start-to-finish compilation to incorporate custom, personalized characters.

21. The computer program of claim 19, further including programming instructions for dynamically generating at least one of a front and back book covers for the start-to-finish compilation.

22. The computer program of claim 19, further including programming instructions for dynamically generating one of an index and a table of contents for the start-to-finish compilation.

23. The computer program of claim 19, further including programming instructions for one of:
dynamically selecting images to accompany the selected portion of the plurality of the user's Internet experience; and
dynamically generating images to accompany the selected portion of the plurality of the user's Internet experience.

24. The computer program of claim 19, further including programming instructions for dynamically generating a listing of related further reading for the start-to-finish compilation.

25. The computer program of claim 19, further including programming instructions for dynamically generating a preselected book feature for the selected portion of the plurality of the user's Internet experience.

26. The computer program of claim 17, further including programming instructions for dynamically generating a non-book compilation for the start-to-finish compilation.

27. The computer program of claim 26, wherein the arranging step further includes generating an audio stream.

28. A computer program for managing a pick-a-path experience for a set of interactive user Internet sessions, comprising:
archiving instructions for archiving user decisions and outcomes of the interactive user Internet sessions; and
handling instructions for compiling and publishing the user decisions and outcomes for one of: a portion of the set of interactive user Internet sessions and the complete set of the interactive user Internet sessions.

29. The computer program of claim 28 wherein the pick-a-path experience is one of: an educational experience, a simulation, an entertainment experience, and a gaming experience.

30. The computer program of claim 29 further including publishing instructions for publishing user decisions and outcomes that have been archived for at least one educational goal.

31. The computer program of claim 28 wherein the handling instructions for compiling and publishing the user decisions and outcomes for one of: a selected intermediate sequence of the set of interactive user Internet sessions and the complete set of the interactive user Internet sessions includes incorporating advertising on printed pages in accordance with a predetermined scheme.

32. A memory unit wherein the computer program of claim 28 is stored thereon.

33. The memory unit of claim 32 wherein the memory unit is one of: a compact disc, a hard drive of a computer, a floppy disk, and a memory unit of a shared database.
